(19) United States
(12) Patent Application Publication
(10) Pub. No.: US 2008/0080011 A1
(43) Pub. Date: Apr. 3, 2008

(54) Printing apparatus

(75) Inventor: Shigeki Hamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/882,705

(22) Filed: Aug. 3, 2007

(30) Foreign Application Priority Data
Sep. 28, 2006 (JP) JP2006-264911

(51) Int. Cl. H04N 1/00

(52) U.S. Cl. 358/401

(57) ABSTRACT

A printing apparatus includes a printing unit printing print job data on a print medium, a registering unit registering items of print characteristic information used for specifying a condition for printing the print job data on the print medium and items of print condition information associated with the print characteristic information, a receiving unit receiving the print job data, a extracting unit analyzing as to whether or not print characteristic information of the received print job data is coincident with the print characteristic information registered in the registering unit, and, if coincident with each other, extracting the print condition information associated therewith from the registering unit, and a control unit controlling, when printing the received print job data, the printing unit on the basis of the extracted print condition information.

### BACKGROUND OF DISCLOSURE

The disclosure relates to a printing apparatus (printer) comprising a, operation mode auto-setting function.

Generally, in the case of changing a type of the printer, there occur changes in print position (alignment) and in a variety of characteristics because of being affected by a tolerance of specifications and a difference between individual apparatuses. For instance, an operation of printing a business form requires, in the case of changing the type of the printer, a post-change printer to keep accuracy of the print position of the pre-change printer equal to or higher than the tolerance of the specifications. Fulfillment of this requirement involves performing, for the post-change printer, a fine adjustment of an operation mode (print conditions) of the printer. The operation mode is exemplified such as the print position and a print density.

[Patent document 1] Japanese Patent Application Laid-Open Publication No. 6-8542

[Patent document 2] Japanese Patent Application Laid-Open Publication No. 6-86033

[Patent document 3] Japanese Patent Application Laid-Open Publication No. 7-1777

[Patent document 4] Japanese Patent Application Laid-Open Publication No. 8-142441

[Patent document 5] Japanese Patent Application Laid-Open Publication No. 9-99607

[Patent document 6] Japanese Patent Application Laid-Open Publication No. 2000-339122

[Patent document 7] Japanese Patent Application Laid-Open Publication No. 2005-316874

### SUMMARY OF DISCLOSURE

In the case of making the fine adjustment in the conventional printer, however, the fine adjustment is reflected in all of printed results. Hence, there might be a possibility of adversely affecting the printing operation having no scheme to apply the fine adjustment. When selecting as to whether the fine adjustment is conducted for every printing operation and when performing the fine adjustment differing according to the printing operation, it is required that the fine adjustment be made by each piece of software, a printer driver, etc, which carry out the printing operation on the side of a host computer (including a server, a personal computer, etc). In the case of conducting the printing operation by a system, even when changing a type of the printer, there exists a case of having none of scheme to change or being disabled to change other components (the host computer, the software, the printer driver, hardware, a print medium, and so on) in the system. If the fine adjustment is made softwarewise, however, such a problem arises that the components in the system are required to be changed in order for the post-change printer to keep the print position of the pre-change printer. Moreover, it is time-consuming to change a printing mechanism provided in the printer and to make the fine adjustment. Furthermore, the change of the printing mechanism provided in the printer and the fine adjustment exert influence uniformly on all of the printing operations, and hence it is impossible to cope with the individual printing operations.

The present apparatus aims at applying the fine adjustment of the operation mode of the printing apparatus to only the specified type of printing operation.

The present apparatus adopts the following means in order to solve the problems. Namely, in one aspect, the present disclosure comprises printing means printing print job data on a print medium, registering means registering items of print characteristic information used for specifying a condition for printing the print job data on the print medium and items of print condition information associated with the print characteristic information, receiving means receiving the print job data, extracting means analyzing as to whether or not print characteristic information of the received print job data is coincident with the print characteristic information registered in the registering means, and, if coincident with each other, extracting the print condition information associated therewith from the registering means, and control means controlling, when printing the received print job data, the printing means on the basis of the extracted print condition information. The present printing apparatus can perform the printing in a way that applies the fine adjustment of the print condition information associated with the print characteristic information to only the specified print job data coincident with the pre-registered print characteristic information. Further, with respect to the print job data of which the print characteristic information is not coincident with the pre-registered print characteristic information, the printing can be done as it is without being affected by the print condition information.

Further, in another aspect of the present disclosure, the items of print characteristic information may be, as items of information unrelated directly to the print condition information, a print job data size, a print date/time, a print job name, a print application name, a user name and a host computer name, and the registering means may register at least one of the print job data size, the print date/time, the print job name, the print application name, the user name and the host computer name, and further may register the print condition information associated with the print job data size, the print date/time, the print job name, the print application name, the user name and the host computer name, which are to be registered.

Moreover, in another aspect of the present disclosure, the items of print condition information may be a print position, a print magnification, a print density, a development parameter, a transfer parameter, a printing speed, a printing interval, a fixing temperature, a print medium size and a print character size, and the registering means may register the print characteristic information and at least one of the print position, the print magnification, the print density, the development parameter, the transfer parameter, the printing speed, the printing interval, the fixing temperature, the print medium size and the print character size, which are associated with the print characteristic information.

Further, in another aspect, the present disclosure includes a method by which a computer, other devices and machines, etc execute any one of the processes. Still further, in another aspect, the present disclosure includes a program that makes the computer, the other devices and machines, etc actualize any one of the functions. Yet further, in another aspect, the present disclosure includes a recording medium recorded with such a program that can be read by the computer etc. Additionally, in another aspect, the present disclosure includes a printing system comprising a printing apparatus having any one of the functions and a host computer transmitting print job data to the printing apparatus.

The fine adjustment of an operation mode of the printing apparatus can be applied to a specified type of printing operation but can not be applied to other general types of printing operations without changing components (the host computer, an operating system, application software, a printer driver, etc) other than the printer in the system.

### BRIEF DESCRIPTION OF THE DRAWINGS

FIG. 1 is a diagram of an architecture of a printer system in the present embodiment.

FIG. 2 is an explanatory flowchart of an operation of a control unit in the present embodiment.

FIG. 3 is a diagram of a structure of a fine adjustment table 9 provided in a recording unit 7.

### DETAILED DESCRIPTION

A printer system according to a best mode (which will hereinafter be termed an embodiment) for carrying out the apparatus will hereinafter be described with reference to the drawings. A configuration in the following embodiment is an exemplification, and the apparatus is not limited to the configuration in the embodiment.

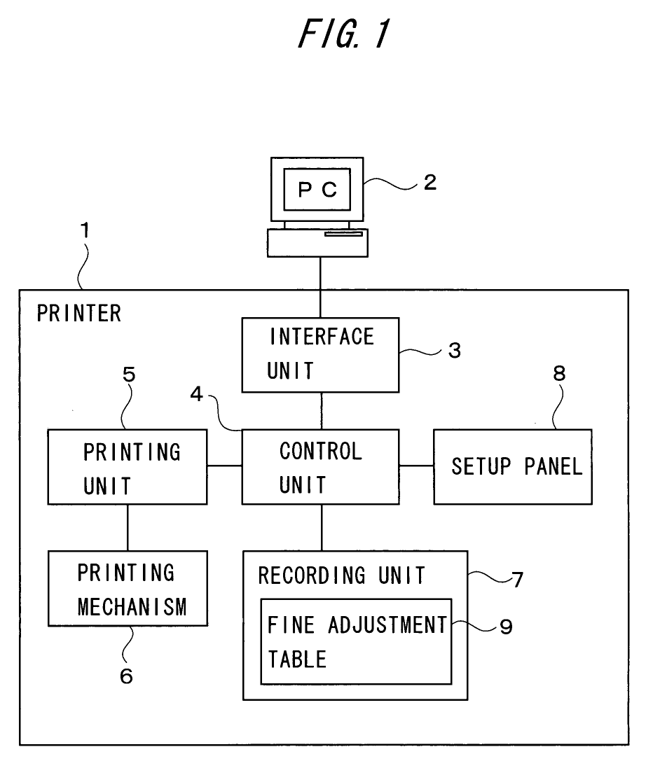

FIG. 1 is a diagram of an architecture of a printer system in the preset embodiment. A printer (printing apparatus) 1 in the present embodiment includes an interface unit 3 that receives data from a personal computer 2, a control unit 4 that controls the whole of the printer 1, a printing unit 5, a printing mechanism 6, a record unit 7 and a setup panel 8. The interface unit 3, which has a function of transmitting and receiving the data, transmits and receives the data to and from the personal computer 2. The personal computer 2 illustrated in FIG. 1 is a general type of computer, and hence its explanation is omitted herein.

The control unit 4 is connected via a bus to the interface unit 3, the printing unit 5, the record unit 7 and the setup panel 8. Further, the control unit 4 gives a print instruction to the printing unit 5. To be specific, the control unit 4 sends, to the printing unit 5, print job data received from the personal computer 2 via the interface unit 3.

The printing unit 5 gives an instruction to the printing mechanism 6 that performs printing on a print medium. In the present embodiment, the print medium is exemplified such as paper and an OHP (OverHead Projector) sheet. Further, the paper includes plain paper and ruled-line paper (such as a slip and a business form). The printing mechanism 6 performs the printing on the print medium according to a preset operation mode.

Moreover, the printing unit 5, when receiving from the control unit 4 a piece of fine adjustment quantity data defined as an instruction of changing the operation mode, gives the printing mechanism 6 the instruction of changing the operation mode set in the printing mechanism 6. The printing mechanism 6 receiving the operation mode change instruction changes the preset operation mode, and conducts the printing on the print medium.

The control unit 4 and the printing unit 5, which are CPUs (Central Processing Units), execute a variety of processes according to programs stored in an unillustrated ROM (Read Only Memory) provided in the printer 1. Further, the processes of the control unit 4 and of the printing unit 5 can be also executed by the single CPU.

The record unit 7 is a nonvolatile memory that stores a characteristic group of print job data and the fine adjustment quantity associated with the characteristic group. The nonvolatile memory may involve using, e.g., a flash memory. A data structure of the print job data is built up by a header field and a print data field subsequent to this header field. The header field is a field, which is on the order of several hundreds of bytes, at the beginning of the print job data. The header field contains items of information such as a print job name, a user name, a personal computer name (host computer name), a generating application name (print application name), a print date/time, a data size and a print job data size. The characteristic group of the print job data represents specified items of data contained in the print job data, and serves to identify the print job data containing the print data as a target for changing the operation mode set in the printing mechanism 6. In the present embodiment, the items of information contained in the header field, which specify the print job data, are set as the characteristic group of the print job data.

Further, the record unit 7 includes a fine adjustment table 9 in which the characteristic group of the print job data is associated with the fine adjustment quantity paired with the characteristic group. The setup panel 8 accepts an input from the user in order to set up the characteristic group (characteristic information) and the fine adjustment quantity (print condition) in the fine adjustment table 9. The setup of the fine adjustment table 9 can be also done on-line via the interface unit 3 and the control unit 4 from on the personal computer 2. This method is much easier to input the setup.

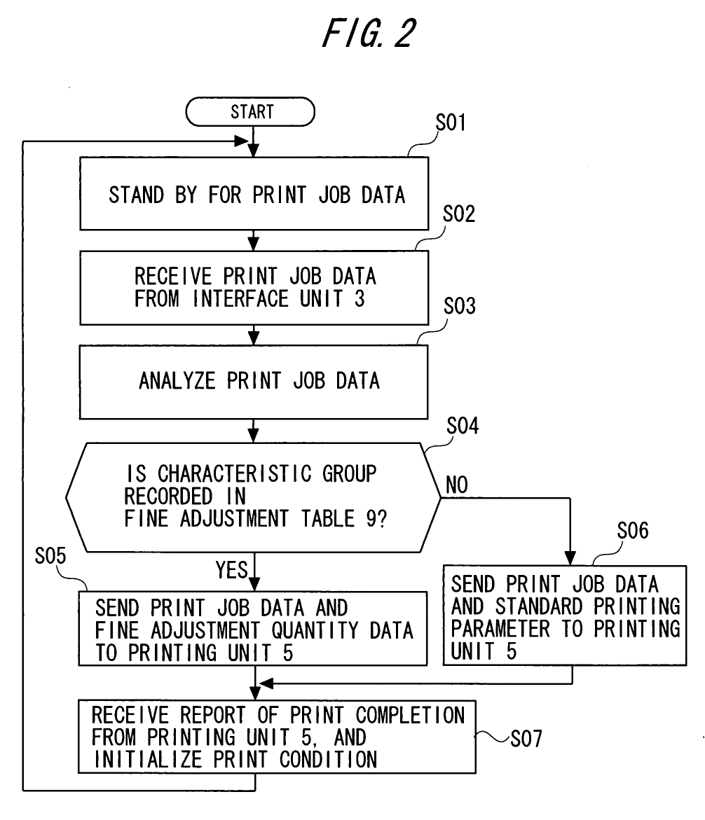

An operation of the control unit 4 in the present embodiment will be described with reference to FIG. 2. FIG. 2 is an explanatory flowchart of the operation of the control unit 4 in the present embodiment.

To start with, the control unit 4 is in a standby status for the print job data. The interface unit 3 receives the print job data from the personal computer 2, which triggers a start of the operation of the control unit 4 (S01). The control unit 4, after the interface unit 3 has received the print job data from the personal computer 2, receives the print job data from the interface unit 3 (S02). Then, the control unit 4 stores the received print job data in a work memory (unillustrated) provided in the printer 1. Further, the control unit 4 analyzes the print job data received from the interface unit 3 (S03). The control unit 4 determines whether or not the fine adjustment table 9 is stored with the characteristic group contained in the print job data received from the interface unit 3 (S04).

If the fine adjustment table 9 is stored with the characteristic group contained in the print job data received from the interface unit 3, the control unit 4 sends, to the printing unit 5, the print job data received from the interface unit 3 and the fine adjustment quantity data associated with the print job data (S05). Whereas if the fine adjustment table 9 is not stored with the characteristic group contained in the print job data received from the interface unit 3, the control unit 4 sends to the printing unit 5 the print job data, as standard print parameters, received from the interface unit 3 (S06).

The control unit 4 receives a report of print completion from the printing unit 5 that has received the print job data. Then, the control unit 4 receiving the report of print completion from the printing unit 5 initializes the operation mode stored in the work memory (S07). The control unit 4, in the case of receiving the report of print completion from the printing unit 5 and initializing the operation mode stored in the work memory, comes to the standby status for the print job data.

The printing unit 5, when receiving the print job data from the control unit 4, controls the printing mechanism 6 to print the print data contained in the print job data on the print medium. A process that the printing mechanism 6 prints the print data on the print medium, is termed a print process in the present embodiment.

The printing unit 5, when receiving the fine adjustment quantity data associated with the print job data, controls the printing mechanism 6 to execute the print process in the operation mode where the fine adjustment quantity data is applied. Namely, the printing unit 5 controls the printing mechanism 6 to print the print data contained in the print job data on the print medium in a way that changes the operation mode, corresponding to the fine adjustment quantity data received from the control unit 4. While on the other hand, if the fine adjustment is not required, the printing unit 5 controls the printing mechanism 6 with the standard print parameters.

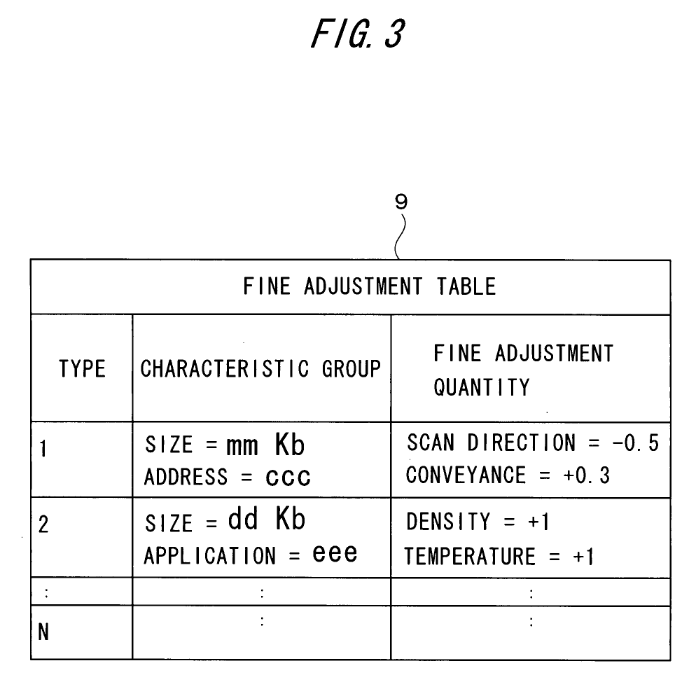

FIG. 3 is a diagram of a structure of the fine adjustment table 9 provided in the record unit 7. The fine adjustment table 9 is stored with the characteristic group of the print job data and the fine adjustment quantity associated with the characteristic group. Characteristics of the print job data are recorded in a field of the characteristic group in the fine adjustment table 9. Further, a change value for changing the operation mode set as a default in the printing mechanism 6 is recorded in a field of the fine adjustment quantity in the fine adjustment table 9.

The characteristic group in the fine adjustment table 9 is used for the control unit 4 to determine which characteristic group stored in the fine adjustment table 9 is contained in the print job data received by the interface unit 3. For example, the print data size contained in the print job data is a specified data size depending on the printing operation. Then, a source address of the print data is a specified address depending on the printing operation. Further, an application for generating the print data is a specified application depending on the printing operation. Therefore, the information contained in the print job data can be utilized as a characteristic for identifying a specified operation.

An example of the print process executed by the printing mechanism 6 will be described with reference to FIG. 3. Supposing that the print data size contained in the print job data received by the interface unit 3 from the personal computer 2 is on the order of mm Kb (kilo bytes) and ccc represents an address specifying a data location, the characteristic is coincident with the characteristic of a type 1, which is recorded in the characteristic group field in the fine adjustment table 9. In this case, the control unit 4 searches through the fine adjustment table 9 and thus extracts the fine adjustment quantity of the type 1 from the fine adjustment table 9. As shown in FIG. 3, the fine adjustment quantity of the type 1, which is extracted by the control unit 4, takes vales such as a scan direction=−5 and conveyance=+0.3. The scan direction and the conveyance are defined as parameters for adjusting a print position. The control unit 4 sends, to the printing unit 5, the extracted values such as the scan direction=−5 and the conveyance=+0.3.

The scan direction=−0.5 recorded in the fine adjustment table 9 connotes that a default value of the scan direction, which is set in the printing mechanism 6, is changed by a value “−0.5”. Further, the conveyance=+0.3 recorded in the fine adjustment table 9 connotes that a default value of the conveyance, which is set in the printing mechanism 6, is changed by a value “+0.3”.

Then, the printing unit 5 changes the default values set in the printing mechanism 6 by the values such as the scan direction=−0.5 and the conveyance=+0.3, and controls the printing mechanism 6 to execute the print process. The printing mechanism 6 performs printing on the print medium by use of the values into which the default values have been changed. For instance, if the default values set in the printing mechanism 6 are changed by the values such as the scan direction=−0.5 and the conveyance=+0.3, the print medium undergoes printing in a state where an X-axis direction of the print medium is changed by 0.5 mm and a Y-axis direction thereof is changed by 0.3 mm.

Supposing that the print data size contained in the print job data received by the interface unit 3 from the personal computer 2 is on the order of dd Kb (kilo bytes) and eee represents an application name of the application employed for generating the print data, the characteristic is coincident with the characteristic of a type 2, which is recorded in the characteristic group field in the fine adjustment table 9. In this case, the control unit 4 searches through the fine adjustment table 9 and thus extracts the fine adjustment quantity of the type 2 from the fine adjustment table 9. As shown in FIG. 3, the fine adjustment quantity of the type 2, which is extracted by the control unit 4, takes values such as a density=+1 and a temperature=+1. The control unit 4 sends, to the printing unit 5, the extracted values such as the density=+1 and the temperature=+1.

Then, the printing unit 5 changes the default values set in the printing mechanism 6 by the values such as the density=+1 and the temperature=+1, and controls the printing mechanism 6 to execute the print process. The printing mechanism 6 performs printing on the print medium by use of the values into which the default values have been changed. For example, the print density for printing on the print medium is categorized into five levels, and the default value of the print density of the printing mechanism 6 is set to “3”. If the default values set in the printing mechanism 6 are changed by the values such as the density=+1 and the temperature=+1, the print medium undergoes printing in a state where the print density of the print medium is 4 and a fixing temperature to the print medium is +1° C.

The printing unit 5, when the print process of the printing mechanism 6 gets completed, sends a report of print completion to the control unit 4. The fine adjustment table 9 shown in FIG. 3 is previously set up. For example, the user manipulates the setup panel 8, thereby enabling the setup of the characteristic group and the fine adjustment quantity in the fine adjustment table 9. Further, for instance, the characteristic group data and the fine adjustment data are captured from the personal computer 2 via the interface unit 3, thereby enabling the setup of the characteristic group and the fine adjustment quantity in the fine adjustment table 9.

The characteristic group in the fine adjustment table 9 contains, in addition to those shown in FIG. 3, e.g., a data pattern, a print executor, an operation pattern, a print job name, a user name, a personal computer name, a date/time, etc., which are contained in the print job data.

The data pattern contained in the print job data has a high possibility of becoming a specified data pattern depending on the printing operation. The print executor contained in the print job data becomes a specified print executor depending on the printing operation. The operation pattern contained in the print job data has a high possibility of becoming a specified operation pattern depending on the printing operation. The print job name contained in the print job data becomes a specified print job name depending on the printing operation. The user name contained in the print job data becomes a specified user name depending on the printing operation. The personal computer name contained in the print job data becomes a specified personal computer name depending on the printing operation. The date/time contained in the print job data has a high possibility of becoming a specified date/time depending on the printing operation. Therefore, these items of information contained in the print job data can be utilized as the characteristics for identifying the specified operation.

The fine adjustment quantity in the fine adjustment table 9 contains, other than those shown in FIG. 3, e.g., a development parameter, a transfer parameter, a printing speed, a printing interval, a main-scan direction print position, a sub-scan direction print position, a lengthwise image expansion/contraction, a crosswise image expansion/contraction, a skew quantity, a sheet size replacement, a character font replacement, etc.

The development parameter represents, e.g., an intensity of voltage and a strength of frequency when adhering toners onto a drum when the printing mechanism 6 includes the drum. Further, the transfer parameter represents, e.g., the intensity of voltage and the strength of frequency when transferring, onto the print medium, the toners adhered onto the drum when the printing mechanism 6 includes the drum. If the print medium is thick paper or the OHP sheet, the voltage for transferring the toners onto the thick paper or the OHP sheet is increased. If the print medium is thin paper, the voltage for transferring the toners onto the thin paper is decreased.

A speed at which to perform printing on the print medium can be changed corresponding to the printing speed. A print magnification can be changed corresponding to the lengthwise image expansion/contraction and the crosswise image expansion/contraction. A size of the print medium can be changed by doing the sheet size replacement. Further, a size of the printing character can be changed by doing the character font replacement. There is a case of scheming to apply these fine adjustment quantities as those for the fine adjustment when printing, depending on the printing operation. Therefore, these fine adjustment quantities are set in the fine adjustment table 9, whereby the default values of the operation mode, which are set in the printing mechanism 6, can be changed.

The control unit 4 determines whether or not the characteristic group contained in the print job data received from the personal computer 2 is recorded in the fine adjustment table 9. If the characteristic group contained in the print job data is recorded in the fine adjustment table 9, the control unit 4 sends the print job data and the fine adjustment quantity data to the printing unit 5. The printing unit 5 receiving the print job data and the fine adjustment quantity data controls the printing mechanism 6 to change the operation mode set in the printing mechanism 6, corresponding to the fine adjustment quantity data.

According to the printer system in the present embodiment, it is possible to perform the printing on the print medium in the operation mode where the fine adjustment is applied to only the specified print job data. Namely, the printing on the print medium can be done in the operation mode where the fine adjustment is applied to only the scheme-to-apply print job data.

Further, according to the printer system in the present embodiment, the printing on the print medium can be conducted in the operation mode where the fine adjustment is applied to only the specified type of printing operation without changing the data structure of the print job data.

Moreover, according to the printer system in the present embodiment, the printing on the print medium can be performed in the operation mode where the fine adjustment is applied to only the specified type of printing operation in a way that changes none of the personal computer 2, the printing software installed into the personal computer 2, the print medium, etc. It is therefore feasible to conduct the printing on the print medium in the operation mode where the fine adjustment is applied to only the specified type of printing operation without requiring any change of the components other than the printer 1.

Furthermore, according to the printer system in the present embodiment, the printing on the print medium can be conducted in the operation mode where the fine adjustment is applied to only the specified type of printing operation without changing the mechanical construction with respect to also the printing mechanism 6 provided in the printer 1.

<Computer Readable Recording Medium>

It is possible to record a program which causes a computer to implement any of the functions described above on a computer readable recording medium. By causing the computer to read in the program from the recording medium and execute it, the function thereof can be provided. The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

<Others>

The disclosures of Japanese patent application No. JP2006-264911 filed on Sep. 28, 2006 including the specification, drawings and abstract are incorporated herein by reference.

What is claimed is:

1. A printing apparatus comprising:
a printing unit printing print job data on a print medium;
a registering unit registering items of print characteristic information used for specifying a condition for printing the print job data on the print medium and items of print condition information associated with the print characteristic information;
a receiving unit receiving the print job data;
a extracting unit analyzing as to whether or not print characteristic information of the received print job data is coincident with the print characteristic information registered in the registering unit, and, if coincident with each other, extracting the print condition information associated therewith from the registering unit; and
a control unit controlling, when printing the received print job data, the printing unit on the basis of the extracted print condition information.

2. A printing apparatus according to claim 1, wherein the items of print characteristic information are, as items of information unrelated directly to the print condition information, a print job data size, a print date/time, a print job name, a print application name, a user name and a host computer name, and
the registering unit registers at least one of the print job data size, the print date/time, the print job name, the print application name, the user name and the host computer name, and further registers the print condition information associated with the print job data size, the print date/time, the print job name, the print application name, the user name and the host computer name, which are to be registered.

3. A printing apparatus according to claim 1, wherein the items of print condition information are a print position, a print magnification, a print density, a development parameter, a transfer parameter, a printing speed, a printing interval, a fixing temperature, a print medium size and a print character size, and
the registering unit registers the print characteristic information and at least one of the print position, the print magnification, the print density, the development parameter, the transfer parameter, the printing speed, the printing interval, the fixing temperature, the print medium size and the print character size, which are associated with the print characteristic information.

4. A printing apparatus according to claim 1, wherein the items of print characteristic information are, as items of information unrelated directly to the print condition information, a print job data size, a print date/time, a print job name, a print application name, a user name and a host computer name,
the items of print condition information are a print position, a print magnification, a print density, a development parameter, a transfer parameter, a printing speed, a printing interval, a fixing temperature, a print medium size and a print character size, and
the registering unit registers at least one of the print job data size, the print date/time, the print job name, the print application name, the user name and the host computer name, and further registers at least one of the print position, the print magnification, the print density, the development parameter, the transfer parameter, the printing speed, the printing interval, the fixing temperature, the print medium size and the print character size that are associated with the print job data size, the print date/time, the print job name, the print application name, the user name and the host computer name, which are to be registered.

5. A control method of a printing apparatus, comprising:
a step of registering, in a registering unit, items of print characteristic information used for specifying a condition for printing print job data on the print medium and items of print condition information associated with the print characteristic information;
a step of receiving the print job data;
a step of analyzing as to whether or not print characteristic information of the received print job data is coincident with the print characteristic information registered in the registering unit, and, if coincident with each other, extracting the print condition information associated therewith from the registering unit; and
a step of controlling, when printing the received print job data, a printing unit printing the print job data on a print medium on the basis of the extracted print condition information.

6. A control method of a printing apparatus according to claim 5, wherein the items of print characteristic information are, as items of information unrelated directly to the print condition information, a print job data size, a print date/time, a print job name, a print application name, a user name and a host computer name, and
the registering step includes registering at least one of the print job data size, the print date/time, the print job name, the print application name, the user name and the host computer name, and further registering the print condition information associated with the print job data size, the print date/time, the print job name, the print application name, the user name and the host computer name, which are to be registered.

7. A control method of a printing apparatus according to claim 5, wherein the items of print condition information are a print position, a print magnification, a print density, a development parameter, a transfer parameter, a printing speed, a printing interval, a fixing temperature, a print medium size and a print character size, and
the registering step includes registering the print characteristic information and at least one of the print position, the print magnification, the print density, the development parameter, the transfer parameter, the printing speed, the printing interval, the fixing temperature, the print medium size and the print character size, which are associated with the print characteristic information.

8. A control method of a printing apparatus according to claim 5, wherein the items of print characteristic information are, as items of information unrelated directly to the print condition information, a print job data size, a print date/time, a print job name, a print application name, a user name and a host computer name,
the items of print condition information are a print position, a print magnification, a print density, a development parameter, a transfer parameter, a printing speed, a printing interval, a fixing temperature, a print medium size and a print character size, and
the registering step includes registering at least one of the print job data size, the print date/time, the print job name, the print application name, the user name and the host computer name, and further registering at least one of the print position, the print magnification, the print density, the development parameter, the transfer parameter, the printing speed, the printing interval, the fixing temperature, the print medium size and the print character size that are associated with the print job data size, the print date/time, the print job name, the print application name, the user name and the host computer name, which are to be registered.

9. A computer readable storage medium storing a control program of a printing apparatus, making a computer execute:
a step of registering, in a registering unit, items of print characteristic information used for specifying a condition for printing print job data on the print medium and items of print condition information associated with the print characteristic information;
a step of receiving the print job data;
a step of analyzing as to whether or not print characteristic information of the received print job data is coincident with the print characteristic information registered in the registering unit, and, if coincident with each other, extracting the print condition information associated therewith from the registering unit; and
a step of controlling, when printing the received print job data, a printing unit printing the print job data on a print medium on the basis of the extracted print condition information.

10. A computer readable storage medium storing a control program of a printing apparatus according to claim 9, wherein the items of print characteristic information are, as items of information unrelated directly to the print condition information, a print job data size, a print date/time, a print job name, a print application name, a user name and a host computer name, and
the registering step includes registering at least one of the print job data size, the print date/time, the print job name, the print application name, the user name and the host computer name, and further registering the print condition information associated with the print job data size, the print date/time, the print job name, the print application name, the user name and the host computer name, which are to be registered.

11. A computer readable storage medium storing a control program of a printing apparatus according to claim 9, wherein the items of print condition information are a print position, a print magnification, a print density, a development parameter, a transfer parameter, a printing speed, a printing interval, a fixing temperature, a print medium size and a print character size, and
the registering step includes registering the print characteristic information and at least one of the print position, the print magnification, the print density, the development parameter, the transfer parameter, the printing speed, the printing interval, the fixing temperature, the print medium size and the print character size, which are associated with the print characteristic information.

12. A computer readable storage medium storing a control program of a printing apparatus according to claim 9, wherein the items of print characteristic information are, as items of information unrelated directly to the print condition information, a print job data size, a print date/time, a print job name, a print application name, a user name and a host computer name,
the items of print condition information are a print position, a print magnification, a print density, a development parameter, a transfer parameter, a printing speed, a printing interval, a fixing temperature, a print medium size and a print character size, and
the registering step includes registering at least one of the print job data size, the print date/time, the print job name, the print application name, the user name and the host computer name, and further registering at least one of the print position, the print magnification, the print density, the development parameter, the transfer parameter, the printing speed, the printing interval, the fixing temperature, the print medium size and the print character size that are associated with the print job data size, the print date/time, the print job name, the print application name, the user name and the host computer name, which are to be registered.

13. A printing system comprising a printing apparatus and a host computer transmitting print job data to the printing apparatus,
the printing apparatus including:
a printing unit printing print job data on a print medium;
a registering unit registering items of print characteristic information used for specifying a condition for printing the print job data on the print medium and items of print condition information associated with the print characteristic information;
a receiving unit receiving the print job data;
a extracting unit analyzing as to whether or not print characteristic information of the received print job data is coincident with the print characteristic information registered in the registering unit, and, if coincident with each other, extracting the print condition information associated therewith from the registering unit; and
a control unit controlling, when printing the received print job data, the printing unit on the basis of the extracted print condition information.

14. A printing system according to claim 13, wherein the items of print characteristic information are, as items of information unrelated directly to the print condition information, a print job data size, a print date/time, a print job name, a print application name, a user name and a host computer name, and
the registering unit registers at least one of the print job data size, the print date/time, the print job name, the print application name, the user name and the host computer name, and further registers the print condition information associated with the print job data size, the print date/time, the print job name, the print application name, the user name and the host computer name, which are to be registered.

15. A printing system according to claim 13, wherein the items of print condition information are a print position, a print magnification, a print density, a development parameter, a transfer parameter, a printing speed, a printing interval, a fixing temperature, a print medium size and a print character size, and
the registering unit registers the print characteristic information and at least one of the print position, the print magnification, the print density, the development parameter, the transfer parameter, the printing speed, the printing interval, the fixing temperature, the print medium size and the print character size, which are associated with the print characteristic information.

16. A printing system according to claim 13, wherein the items of print characteristic information are, as items of information unrelated directly to the print condition information, a print job data size, a print date/time, a print job name, a print application name, a user name and a host computer name,
the items of print condition information are a print position, a print magnification, a print density, a development parameter, a transfer parameter, a printing speed, a printing interval, a fixing temperature, a print medium size and a print character size, and
the registering unit registers at least one of the print job data size, the print date/time, the print job name, the print application name, the user name and the host computer name, and further registers at least one of the print position, the print magnification, the print density, the development parameter, the transfer parameter, the printing speed, the printing interval, the fixing temperature, the print medium size and the print character size that are associated with the print job data size, the print date/time, the print job name, the print application name, the user name and the host computer name, which are to be registered.
